(19) United States
(12) Patent Application Publication
(10) Pub. No.: US 2016/0223335 A1
(43) Pub. Date: Aug. 4, 2016

(54) INFORMATION PROCESSING DEVICE, INFORMATION PROCESSING METHOD, AND COMPUTER-READABLE NON-TRANSITORY STORAGE MEDIUM STORING INFORMATION PROCESSING PROGRAM

(71) Applicant: CASIO COMPUTER CO., LTD., Tokyo (JP)

(72) Inventor: Yuji TABATA, Tokyo (JP)

(73) Assignee: CASIO COMPUTER CO., LTD., Tokyo (JP)

(21) Appl. No.: 15/006,922

(22) Filed: Jan. 26, 2016

(30) Foreign Application Priority Data
Jan. 30, 2015 (JP) 2015-017527

(51) Int. Cl. G01C 21/16; G01C 21/28; G01C 21/26

(52) U.S. Cl. CPC G01C 21/16; G01C 21/26; G01C 21/28

(57) ABSTRACT

An information processing device comprises:

an acceleration detector which detects an acceleration;

a first traveling direction detector which detects a first traveling direction based on a detection result from the acceleration detector;

an angular velocity detector which detects an angular velocity;

a second traveling direction detector which detects a second traveling direction based on a detection result from the angular velocity detector;

a traveling direction estimating unit which estimates a traveling direction of the information processing device based on a change in a traveling direction common to a change in the first traveling direction and a change in the second traveling direction; and

a position estimating part which estimates a position of the information processing device based on an estimation result from the traveling direction estimating unit.

This application is based on and claims the benefit of priority from Japanese Patent Application No. 2015-017527, filed on 30 Jan. 2015, the content of which is incorporated herein by reference.

### BACKGROUND OF THE INVENTION

1. Related Art

The present invention relates to an information processing device, an information processing method, and a computer-readable non-transitory storage medium storing an information processing program.

2. Field of the Invention

A conventionally known portable information processing device such as a smartphone displays a current position based on positional information obtained for example from a global positioning system (GPS). There has also been a known information processing device including various built-in sensors (such as a magnetic sensor, an angular velocity sensor, and an acceleration sensor) and having a function of measuring a position autonomously (autonomous position measuring function).

These information processing devices may be unable to receive a signal from outside, such as a signal from a GPS, when placed in the shadow of a building or indoors, for example. In this case, the accuracy of the autonomous position measuring function becomes an important issue.

An information processing device having a function of obtaining positional information is disclosed in Japanese Patent Application Publication No. 2012-122892, for example.

Regarding implementation of the autonomous position measuring function, positional information is obtained based on traveling direction and velocity during walking, for example. Meanwhile, in the case of a portable information processing device, the device is used in a variety of situations such as the posture of the device not being fixed during use or a way the device is held and a way the device is carried being changed as needed. This makes it difficult to detect traveling direction and velocity accurately.

### SUMMARY OF THE INVENTION

An information processing device according to the present invention comprises:

an acceleration detector which detects an acceleration;

a first traveling direction detector which detects a first traveling direction based on a detection result from the acceleration detector;

an angular velocity detector which detects an angular velocity;

a second traveling direction detector which detects a second traveling direction based on a detection result from the angular velocity detector;

a traveling direction estimating unit which estimates a traveling direction of the information processing device based on a change in a traveling direction common to a change in the first traveling direction and a change in the second traveling direction; and

a position estimating part which estimates a position of the information processing device based on an estimation result from the traveling direction estimating unit.

An information processing method according to the present invention is implemented in an information processing device comprising an acceleration detecting means which detects an acceleration and an angular velocity detecting means which detects an angular velocity.

The information processing method comprises:

detecting a first traveling direction based on a detection result from the acceleration detecting means;

detecting a second traveling direction based on a detection result from the angular velocity detecting means;

estimating a traveling direction of the information processing device based on a change in a traveling direction common to a change in the first traveling direction and a change in the second traveling direction; and

estimating a position of the information processing device based on an estimation result about the traveling direction of the information processing device.

A computer-readable non-transitory storage medium according to the present invention stores an information processing program which causes a computer controlling an information processing device to function.

The information processing device comprises an acceleration detecting means which detects an acceleration and an angular velocity detecting means which detects an angular velocity.

The function of the computer comprises:

detecting a first traveling direction based on a detection result from the acceleration detecting means;

detecting a second traveling direction based on a detection result from the angular velocity detecting means;

estimating a traveling direction of the information processing device based on a change in a traveling direction common to a change in the first traveling direction and a change in the second traveling direction; and

estimating a position of the information processing device based on an estimation result from the traveling direction estimating function.

### BRIEF DESCRIPTION OF THE DRAWINGS

This application can be better understood by considering the following detailed description in combination with the following drawings.

FIG. 1 is a schematic view showing the structure of the external appearance of an information processing device according to an embodiment of the present invention.

FIG. 2 is a block diagram showing the hardware structure of the information processing device according to the embodiment of the present invention.

FIG. 3 is a functional block diagram showing a functional structure to execute autonomous positioning processing forming the functional structure of the information processing device shown in FIG. 2.

FIG. 4 is a flowchart explaining a flow of the autonomous positioning processing executed by the information processing device of FIG. 1 having the functional structure of FIG. 3.

FIG. 5 is a flowchart explaining a flow of posture detecting processing.

FIG. 6 is a flowchart explaining a flow of walk detecting processing.

FIG. 7 is a flowchart explaining a flow of traveling direction detecting processing.

FIG. 8 is a flowchart explaining a flow of acceleration traveling direction detecting processing.

FIG. 9 is a flowchart explaining a flow of angular velocity traveling direction detecting processing.

FIG. 10 is a flowchart explaining a flow of autonomous position updating processing.

### DETAILED DESCRIPTION OF THE INVENTION

An embodiment of the present invention will be described below by referring to the drawings.

### [Hardware Structure]

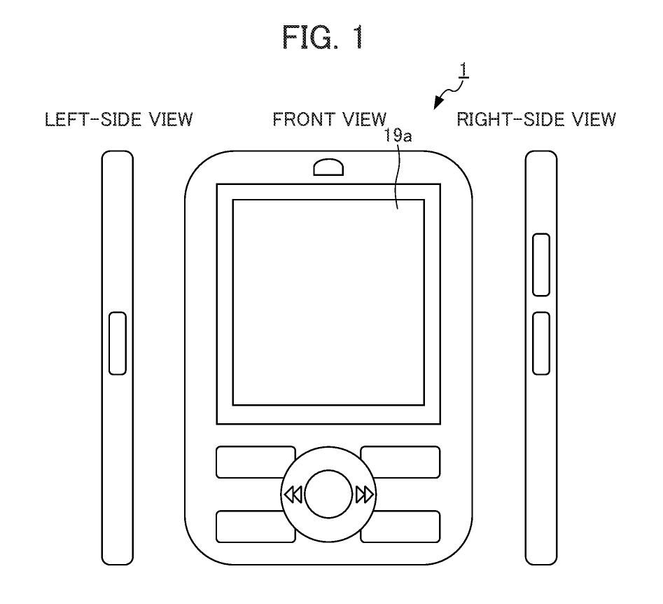

FIG. 1 is a schematic view showing the structure of the external appearance of an information processing device 1 according to an embodiment of the present invention.

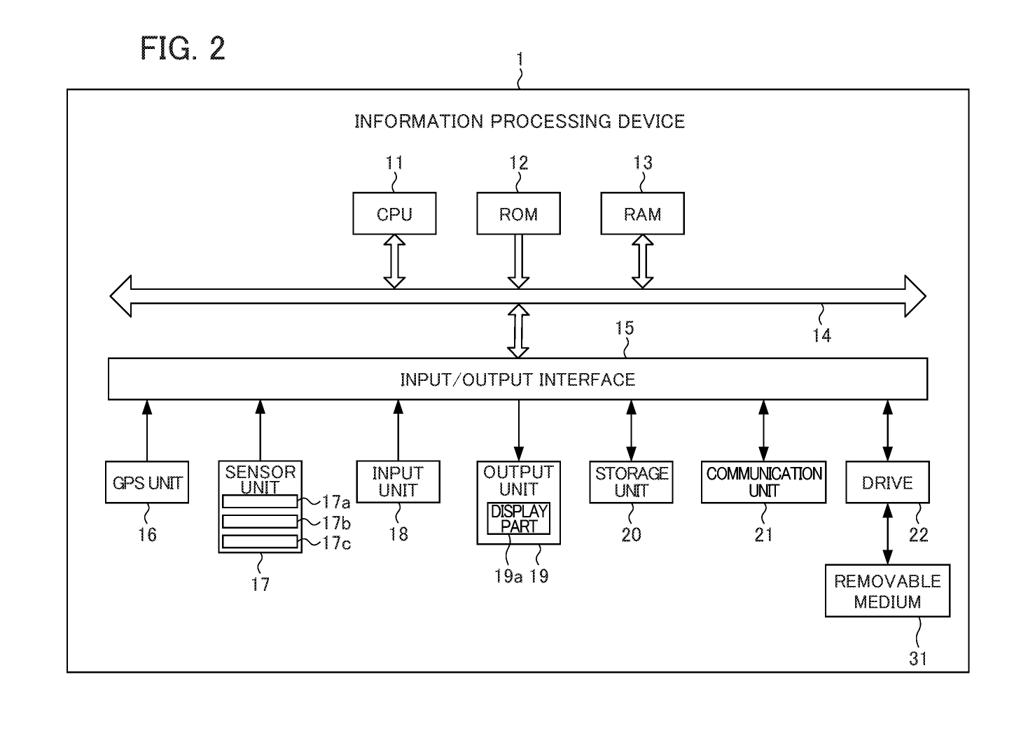

FIG. 2 is a block diagram showing the hardware structure of the information processing device 1 according to the embodiment of the present invention.

The information processing device 1 is configured as a smartphone, for example.

The information processing device 1 includes a CPU (Central Processing Unit) 11, ROM (Read Only Memory) 12, RAM (Random Access Memory) 13, a bus 14, an input/output interface 15, a GPS (Global Positioning System) unit 16, a sensor unit 17, and input unit 18, an output unit 19, a storage unit 20, a communication unit 21 and a drive 22.

The CPU 11 executes various processing in accordance with a program recorded in the ROM 12, or a program loaded from the storage unit 20 into the RAM 13. For example, the CPU 11 executes autonomous positioning processing in accordance with a program for autonomous positioning processing described later.

Data, etc. required upon the CPU 11 executing the various processing is stored in the RAM 13 as appropriate.

The CPU 11, ROM 12 and RAM 13 are connected to each other via the bus 14. In addition, the input/output interface 15 is also connected to this bus 14. The GPS unit 16, sensor unit 17, input unit 18, output unit 19, storage unit 20, communication unit 21 and drive 22 are connected to the input/output interface 15.

The GPS unit 16 includes an antenna, and obtains positional information of the information processing device 1 by receiving GPS signals sent from a plurality of GPS satellites.

The sensor unit 17 includes various sensors such as an acceleration sensor 17a, an angular velocity sensor 17b, and a geomagnetic sensor 17c. A local coordinate system is defined for the information processing device 1. On this local coordinate system, when a display part 19a is viewed from the front, a right-to-left direction of the device is defined as an x axis, a top-to-bottom direction of the device is defined as a y axis, and a front-to-back direction of the device is defined as a z axis. An absolute coordinate system (world coordinate system) is also defined for the information processing device 1. On this absolute coordinate system, an east-to-west direction is defined as an X axis, a north-to-south direction is defined as a Y axis, and a vertical direction is defined as a Z axis.

The acceleration sensor 17a detects an acceleration in the direction of each of the three axes (on the local coordinate system) defined for the information processing device 1.

The angular velocity sensor 17b detects an angular velocity about each of the three axes (on the local coordinate system) defined for the information processing device 1.

The geomagnetic sensor 17c detects orientation of the geomagnetism (specifically, the north-pointing direction in the north-to-south direction). Based on the orientation of the geomagnetism detected by the geomagnetic sensor 17c, the absolute coordinate system and the local coordinate system are converted to each other.

The input unit 18 is formed of various buttons and capacitive or resistive position input sensors stacked in a display region of the display part 19a, and the like. In response to an operation to give a command from a user, various types of information are input to the input unit 18.

The output unit 19 is formed of the display part 19a on which an image is output according to a command from the CPU 11 and a speaker for voice output, etc. For example, various images and a user interface screen are displayed on the display part 19a. In this embodiment, the position input sensors of the input unit 18 are superimposed on the display part 19a to form a touch panel.

The storage unit 20 is configured by a hard disk, DRAM (Dynamic Random Access Memory) or the like, and stores the data of various images.

The communication unit 21 controls communication to be performed with another device (not illustrated) via a network including the Internet.

Removable medium 31 made from a magnetic disk, optical disk, magneto-optical disk, semiconductor memory or the like is installed as appropriate in the drive 22. A program read from the removable media 31 by the drive 22 is installed in the storage unit 20 as necessary. In addition, similarly to the storage unit 20, the removable medium 31 can store various data such as the data of images stored in the storage unit 20.

### [Functional Structure]

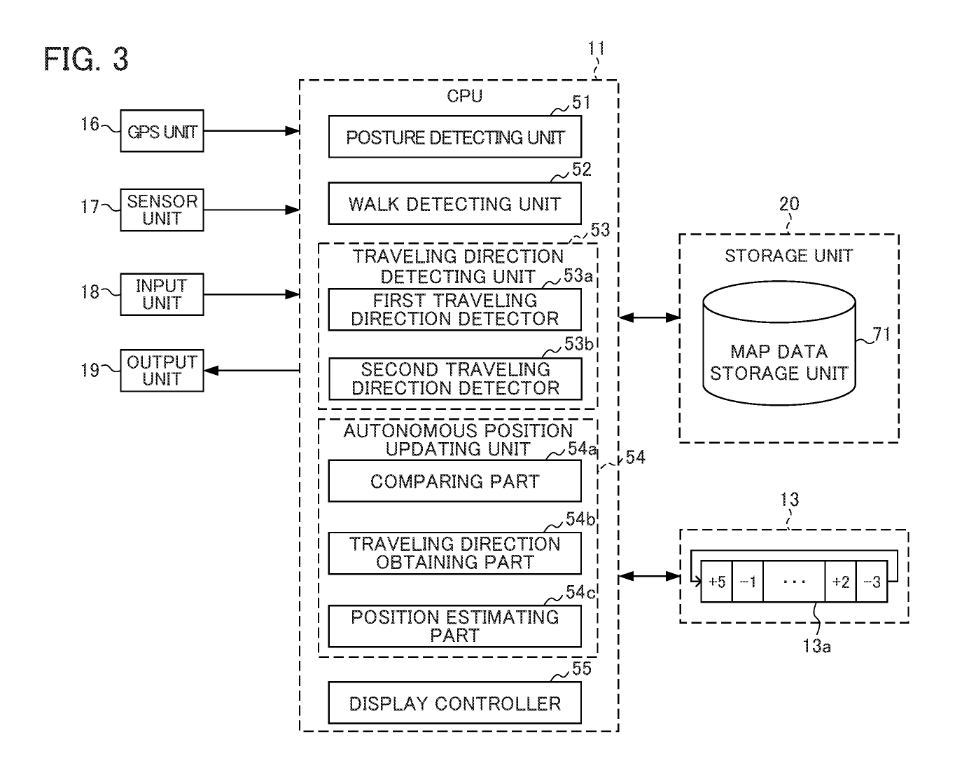

A functional structure to execute autonomous positioning processing forming the functional structure of the information processing device 1 is described next by referring to FIG. 3.

FIG. 3 is a functional block diagram showing a functional structure to execute the autonomous positioning processing forming the functional structure of the information processing device 1 shown in FIG. 2. FIG. 3 also shows an example of change in a traveling direction stored in a ring buffer 13a. Change in a traveling direction is shown in terms of a right-hand direction relative to the Z axis defined as a + direction and a left-hand direction relative to the Z axis defined as a − direction. Change in a traveling direction is expressed in terms of a pointing direction (right-hand or left-hand direction) and a quantity (magnitude of the change in this pointing direction).

The autonomous positioning processing is a series of processing of comparing change (ΔDa) in a traveling direction obtained based on a detection result from the acceleration sensor 17a (hereinafter called a “traveling direction Da”) and change (ΔDw) in a traveling direction obtained based on a detection result from the angular velocity sensor 17b (hereinafter called a “traveling direction Dw”) relative to a current traveling direction and estimating a user's traveling direction based on detected change in a traveling direction common to the changes ΔDa and ΔDw, thereby autonomously obtaining a current position.

As shown in FIG. 3, for execution of the autonomous positioning processing, a posture detecting unit 51, a walk detecting unit 52, a traveling direction detecting unit 53, and an autonomous position updating unit 54 function in the CUP 11.

The ring buffer 13a is defined in a partial region of the RAM 13.

A map data storage unit 71 is defined in a partial region of the storage unit 20.

The ring buffer 13a contains values indicative of the change ΔDw in the traveling direction Dw obtained based on an angular velocity detected by the angular velocity sensor 17b (for example, a value of an angle indicative of orientation change relative to the north-pointing direction). These values are stored cyclically for a constant period of time (1.5 [s], for example). Specifically, the ring buffer 13a contains values indicative of the change ΔDw in the traveling direction Dw obtained every given period of time (such as 20 [ms], for example) based on a detection result from the angular velocity sensor 17b. These values are stored in order in corresponding storage regions of the ring buffer 13a designated cyclically. In this embodiment, the acceleration sensor 17a detects a value of a current acceleration using data about the waveform of acceleration in a constant period of time in the past (hereinafter called a “reference period of time”). Meanwhile, the angular velocity sensor 17b detects an instantaneous value of angular velocity. For comparison of the change ΔDw in the traveling direction Dw to the change ΔDa in the traveling direction Da obtained from a value of the latest acceleration reflecting the state of acceleration change within the reference period of time, the change ΔDw in the traveling direction Dw within the reference period of time is to be accumulated for this reflection. To achieve this, the ring buffer 13a stores each value indicative of the change ΔDw in the traveling direction Dw for the reference period of time obtained based on a detection result from the angular velocity sensor 17b.

The map data storage unit 71 stores data about a map to be displayed in the autonomous positioning processing.

The posture detecting unit 51 executes posture detecting processing, which will be described later, to obtain a value of acceleration detected by the acceleration sensor 17a, a value of angular velocity detected by the angular velocity sensor 17b, and an orientation of the geomagnetism (value on the local coordinate system) detected by the geomagnetic sensor 17c. Further, the posture detecting unit 51 generates posture information about the information processing device 1. The posture information indicates a direction on the absolute coordinate system in which each of the x, y, and z axes of the local coordinate system points. When the information processing device 1 is at a standstill, the posture detecting unit 51 generates posture information about the information processing device 1 directly from the sensor outputs based on the value of acceleration detected by the acceleration sensor 17a and the orientation of the geomagnetism detected by the geomagnetic sensor 17c. When the information processing device 1 is not at a standstill, the posture detecting unit 51 generates posture information about the information processing device 1 by time-integrating the value of angular velocity detected by the angular velocity sensor 17b and adding the resultant value as change relative to posture information generated immediately before. Additionally, the posture detecting unit 51 converts the value of acceleration detected by the acceleration sensor 17a, the value of angular velocity detected by the angular velocity sensor 17b, and the orientation of the geomagnetism detected by the geomagnetic sensor 17c to values on the absolute coordinate system and stores the converted values in the RAM 13.

The walk detecting unit 52 executes walk detecting processing, which will be described later, to detect a peak cycle and a peak amplitude in a waveform represented by a component in the Z-axis direction of acceleration on the absolute coordinate system. Then, based on whether or not the peak cycle and the peak amplitude are within their respective determined threshold ranges, the walk detecting unit 52 determines whether or not a user is walking. If determining that the user is walking, the walk detecting unit 52 updates the traveling velocity based on the magnitude of the peak amplitude.

The traveling direction detecting unit 53 executes traveling direction detecting processing, which will be described later, to detect the traveling direction Da based on a detection result from the acceleration sensor 17a. Further, the traveling direction detecting unit 53 detects the change ΔDw in the traveling direction Dw based on a detection result from the angular velocity sensor 17b.

More specifically, the traveling direction detecting unit 53 includes a first traveling direction detector 53a and a second traveling direction detector 53b.

The first traveling direction detector 53a detects a characteristic point (a peak or a zero-cross point) of acceleration change on the XY plane of the absolute coordinate system and obtains the traveling direction Da on the XY plane using cumulative changes of the characteristic point. For example, the first traveling direction detector 53a obtains the traveling direction Da based on a result of statistical analysis (experimental value) about a pattern of the characteristic point of acceleration change on the XY plane of the absolute coordinate system.

The second traveling direction detector 53b integrates changes in a Z-axis component of an angular velocity on the absolute coordinate system (an angular velocity about the Z axis) and stores a cumulative result obtained every given period of time as the change ΔDw in the traveling direction Dw in the ring buffer 13a cyclically.

Generally, staggering motion due to a user carrying the information processing device 1 is recognized as angular velocity change and tends to be considered to be an error. Change in a way of holding the information processing device 1 by the user of the information processing device 1 is recognized as acceleration change and tends to be considered to be an error.

The autonomous position updating unit 54 executes autonomous position updating processing, which will be described later, to compare the change ΔDa in the traveling direction Da and the change ΔDw in the traveling direction Dw by referring to the ring buffer 13a. Then, the autonomous position updating unit 54 employs change in a traveling direction common to the changes ΔDa and ΔDw as change in a traveling direction free from error and updates the autonomous positional information. The autonomous positional information indicates a result of autonomous position detection obtained by using a detection result from the acceleration sensor 17a and a detection result from the angular velocity sensor 17b without using a GPS signal.

More specifically, the autonomous position updating unit 54 includes a comparing part 54a, a traveling direction obtaining part 54b, and a position estimating part 54c.

The comparing part 54a obtains the change ΔDa in the traveling direction Da obtained by the first traveling direction detector 53a based on the current traveling direction. Then, the comparing part 54a compares the change ΔDa in the traveling direction Da and the change ΔDw in the traveling direction Dw stored in the ring buffer 13a by the second traveling direction detector 53b. More specifically, if the change ΔDa in the traveling direction Da points in the right-hand direction relative to the Z axis, the comparing part 54a erases data about the right-hand direction in chronological order belonging to data about the change ΔDw in the traveling direction Dw stored in the ring buffer 13a and having the same quantity as the change ΔDa in the traveling direction Da. Further, if the change ΔDa in the traveling direction Da points in the left-hand direction relative to the Z axis, the comparing part 54a erases data about the left-hand direction in chronological order belonging to the data about the change ΔDw in the traveling direction Dw stored in the ring buffer 13a and having the same quantity as the change ΔDa in the traveling direction Da. At this time, if the change ΔDa in the traveling direction Da is larger than a total quantity of the change ΔDw in the traveling direction Dw pointing in the right-hand or left-hand direction stored in the ring buffer 13a, the comparing part 54a subtracts an excess of the change ΔDa over the total quantity of the change ΔDw in the traveling direction Dw (a quantity corresponding to the change ΔDw in the traveling direction Dw not stored in the ring buffer 13a) from the traveling direction Da. On the other hand, if the change ΔDa in the traveling direction Da is smaller than the total quantity of the change ΔDw in the traveling direction Dw pointing in the right-hand or left-hand direction stored in the ring buffer 13a, the comparing part 54a ignores an excess of the change ΔDw over the change ΔDa in the traveling direction Da (a quantity corresponding to the change ΔDw in the traveling direction Dw remaining in the ring buffer 13a after the erasure).

As a result of the aforementioned processing, change in a traveling direction only contained in the change ΔDw in the traveling direction Dw and change in a traveling direction only contained in the change ΔDa in the traveling direction Da can be removed as errors. Thus, change in a traveling direction common to the change ΔDw in the traveling direction Dw and the change ΔDa in the traveling direction Da can be reflected in a traveling direction of a user. Specifically, if the change ΔDw in the traveling direction Dw and the change ΔDa in the traveling direction Da point in the same direction, this pointing direction is considered to be a common pointing direction of change. Further, a quantity of the change ΔDw in the traveling direction Dw and a quantity of the change ΔDa in the traveling direction Da are compared and the smaller of the quantities is determined to be a common quantity, thereby obtaining common change in a traveling direction.

The traveling direction obtaining part 54b obtains a current traveling direction based on a comparison result from the comparing part 54a. More specifically, the traveling direction obtaining part 54b adds the change in a traveling direction common to the change ΔDw in the traveling direction Dw and the change ΔDa in the traveling direction Da to a current traveling direction, thereby updating the current traveling direction. Further, if a user is determined not to be walking (specifically, if the information processing device 1 is determined to be at a standstill), the traveling direction obtaining part 54b initializes the ring buffer 13a. At this time, the traveling direction obtaining part 54b obtains an angle by dividing 180 degrees by half of the number of storage regions and determines the obtained angle to be an initial value of each of the change ΔDw in the traveling direction Dw pointing in the right-hand direction and the change ΔDw in the traveling direction Dw pointing in the left-hand direction. Then, the traveling direction obtaining part 54b stores the resultant angle in the right-hand or left-hand direction in each region of the ring buffer 13a. When the comparing part 54a is to compare the change ΔDa in the traveling direction Da to the change ΔDw in the traveling direction Dw stored in the ring buffer 13a for the first time after the ring buffer 13a is initialized in this way (at the start of walking, for example), an angle corresponding to 180 degrees can be ensured as a buffer as change in a traveling direction common to the change ΔDw in the traveling direction Dw and the change ΔDa in the traveling direction Da. Unlike resetting the ring buffer 13a to zero, this can prevent the comparing part 54a from determining all the change ΔDa in the traveling direction Da to be an error when the comparing part 54a makes the comparison for the first time after the ring buffer 13a is initialized. Additionally, the change in a traveling direction occurring when the information processing device 1 in a standstill state starts to move can be reflected readily.

The position estimating part 54c estimates a current position sequentially based on a traveling direction obtained by the traveling direction obtaining part 54b and an acceleration detected by the acceleration sensor 17a and updates the autonomous positional information.

A display controller 55 displays a current position estimated by the position estimating part 54c on a map by referring to a map database.

### [Operation]

Operation will be described next.

### [Autonomous Positioning Processing]

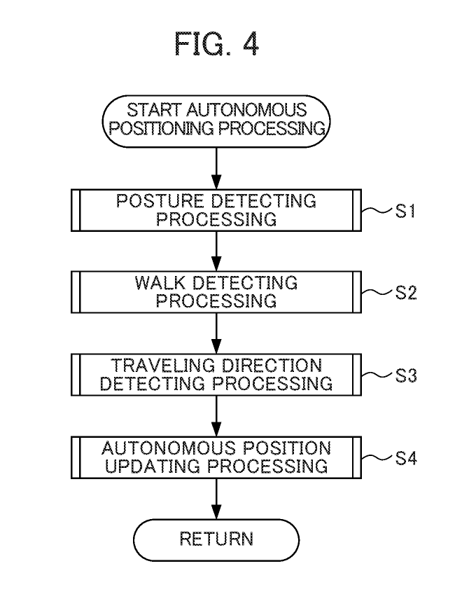

FIG. 4 is a flowchart explaining a flow of the autonomous positioning processing executed by the information processing device 1 of FIG. 1 having the functional structure of FIG. 3.

The autonomous positioning processing is started when the GPS unit 16 becomes unable to receive a GPS signal while the information processing device 1 is placed in a setting to measure a current position.

In step S1, the posture detecting unit 51 executes posture detecting processing (described later).

In step S2, the walk detecting unit 52 executes walk detecting processing (described later).

In step S3, the traveling direction detecting unit 53 executes traveling direction detecting processing (described later).

In step S4, the autonomous position updating unit 54 executes autonomous position updating processing (described later).

After step S4, the autonomous positioning processing is repeated.

The autonomous positioning processing is finished when the GPS unit 16 becomes able to receive a GPS signal.

### [Posture Detecting Processing]

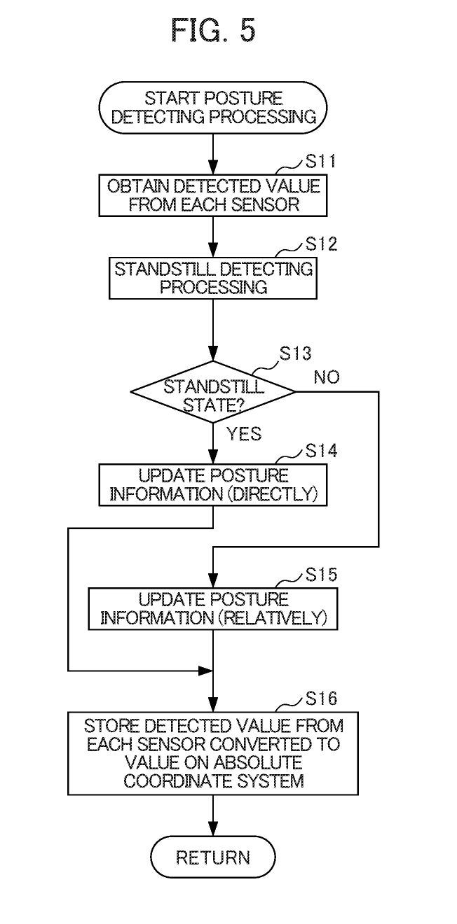

FIG. 5 is a flowchart explaining a flow of the posture detecting processing.

In step S11, the posture detecting unit 51 obtains a value of acceleration detected by the acceleration sensor 17a, a value of angular velocity detected by the angular velocity sensor 17b, and an orientation of the geomagnetism (value on the local coordinate system) detected by the geomagnetic sensor 17c.

In step S12, the posture detecting unit 51 executes standstill detecting processing. In the standstill detecting processing, whether or not the information processing device 1 is in a standstill state is detected based on whether or not the detected value from each sensor is within a predetermined threshold range.

In step S13, the posture detecting unit 51 determines whether or not the information processing device 1 is at a standstill.

If the information processing device 1 is at a standstill, determination in step S13 becomes YES and the processing shifts to step S14.

On the other hand, if the information processing device 1 is not at a standstill, determination in step S13 becomes NO and the processing shifts to step S15.

In step S14, the posture detecting unit 51 generates posture information about the information processing device 1 directly from the sensor outputs based on the value of acceleration detected by the acceleration sensor 17a and the orientation of the geomagnetism detected by the geomagnetic sensor 17c.

After step S14, the processing shifts to step S16. In step S15, the posture detecting unit 51 time-integrates the value of angular velocity detected by the angular velocity sensor 17b and adds the resultant value as change relative to posture information generated immediately before, thereby generating posture information about the information processing device 1.

In step S16, the posture detecting unit 51 converts the value of acceleration detected by the acceleration sensor 17a, the value of angular velocity detected by the angular velocity sensor 17b, and the orientation of geomagnetism detected by the geomagnetic sensor 17c to values on the absolute coordinate system and stores the converted values in the RAM 13.

After step S15, the processing returns to the autonomous positioning processing.

### [Walk Detecting Processing]

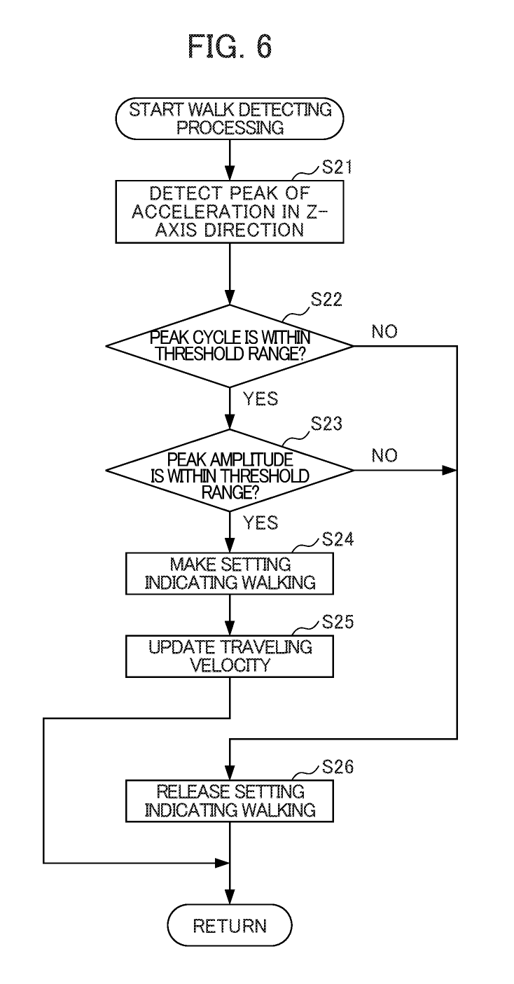

FIG. 6 is a flowchart explaining a flow of the walk detecting processing.

In step S21, the walk detecting unit 52 detects a peak cycle and a peak amplitude in a waveform represented by a component in the Z-axis direction of acceleration on the absolute coordinate system.

In step S22, the walk detecting unit 52 determines whether or not the detected peak cycle is within a predetermined peak threshold range.

If the detected peak cycle is within the predetermined peak threshold range, determination in step S22 becomes YES and the processing shifts to step S23.

On the other hand, if the detected peak cycle is out of the predetermined peak threshold range, determination in step S22 becomes NO and the processing shifts to step S26.

In step S23, the walk detecting unit 52 determines whether or not the detected peak amplitude is within a predetermined amplitude threshold range.

If the detected peak amplitude is within the predetermined amplitude threshold range, determination in step S23 becomes YES and the processing shifts to step S24.

On the other hand, if the detected peak amplitude is out of the predetermined amplitude threshold range, determination in step S23 becomes NO and the processing shifts to step S26.

In step S24, the walk detecting unit 52 makes a setting indicating that a user is walking (turns a flag indicating walking ON).

In step S25, the walk detecting unit 52 updates a traveling velocity of the user during a walk based on the magnitude of the detected peak amplitude. At this time, the traveling velocity of the user during a walk can be obtained based on the magnitude of the peak amplitude by referring to a result of statistical analysis (experimental values) about a relationship between the respective magnitudes of peak amplitudes of a plurality of test subjects during walking and their traveling velocities, for example.

After step S25, the processing returns to the autonomous positioning processing.

In step S26, the walk detecting unit 52 releases the setting indicating that the user is walking (turns the flag indicating walking OFF). Specifically, in step S26, if one or both of the detected peak cycle and the detected peak amplitude are out of their predetermined threshold ranges, the walk detecting unit 52 determines that the user is not walking.

After step S26, the processing returns to the autonomous positioning processing.

### [Traveling Direction Detecting Processing]

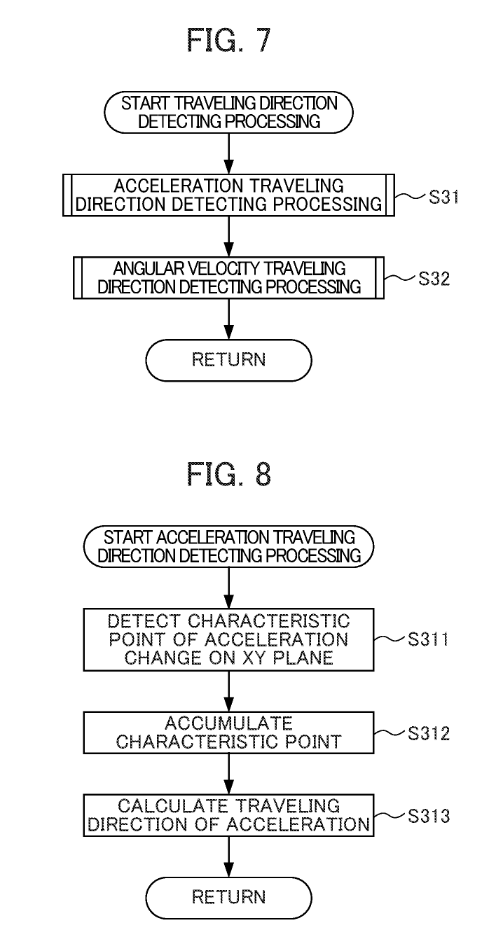

FIG. 7 is a flowchart explaining a flow of the traveling direction detecting processing.

In step S31, the traveling direction detecting unit 53 executes acceleration traveling direction detecting processing (described later).

In step S32, the traveling direction detecting unit 53 executes angular velocity traveling direction detecting processing (described later).

After step S32, the processing returns to the autonomous positioning processing.

### [Acceleration Traveling Direction Detecting Processing]

FIG. 8 is a flowchart explaining a flow of the acceleration traveling direction detecting processing.

In step S311, the first traveling direction detector 53a detects a characteristic point (a peak or a zero-cross point) of acceleration change on the XY plane of the absolute coordinate system.

In step S312, the first traveling direction detector 53a accumulates the detected characteristic point of acceleration change.

In step S313, the first traveling direction detector 53a obtains the traveling direction Da on the XY plane based on the cumulative changes of the characteristic point of acceleration change.

After step S313, the processing returns to the traveling direction detecting processing.

### [Angular Velocity Traveling Direction Detecting Processing]

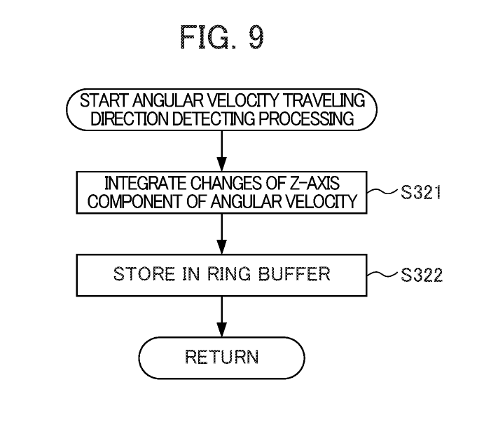

FIG. 9 is a flowchart explaining a flow of the angular velocity traveling direction detecting processing.

In step S321, the second traveling direction detector 53b integrates changes in a Z-axis component of an angular velocity on the absolute coordinate system (an angular velocity about the Z axis).

In step S322, the second traveling direction detector 53b stores a cumulative result obtained every given period of time as the change ΔDw in the traveling direction Dw in the ring buffer 13a cyclically.

After step S322, the processing returns to the traveling direction detecting processing.

### [Autonomous Position Updating Processing]

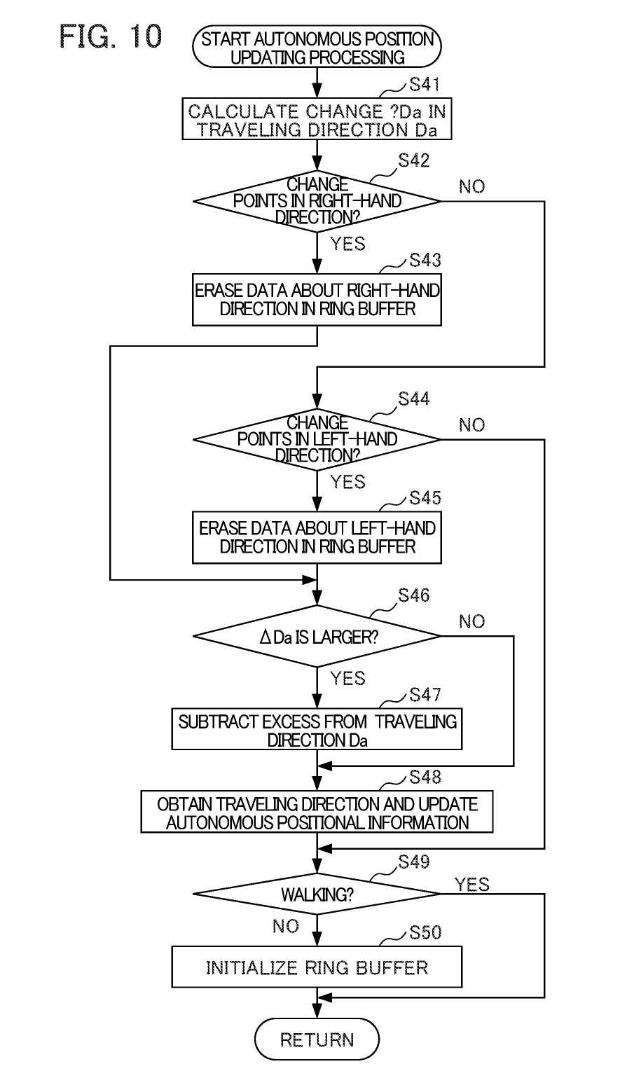

FIG. 10 is a flowchart explaining a flow of the autonomous position updating processing.

In step S41, the comparing part 54a obtains the change ΔDa in the traveling direction Da obtained by the first traveling direction detector 53a based on a current traveling direction.

In step S42, the comparing part 54a determines whether or not the change ΔDa in the traveling direction Da points in the right-hand direction relative to the Z axis.

If the change ΔDa in the traveling direction Da points in the right-hand direction relative to the Z axis, determination in step S42 becomes YES and the processing shifts to step S43.

On the other hand, if the change ΔDa in the traveling direction Da does not point in the right-hand direction relative to the Z axis, determination in step S42 becomes NO and the processing shifts to step S44.

In step S43, the comparing part 54a erases data about the right-hand direction in chronological order belonging to data about the change ΔDw in the traveling direction Dw stored in the ring buffer 13a and having the same quantity as the change ΔDa in the traveling direction Da.

After step S43, the processing shifts to step S46.

In step S44, the comparing part 54a determines whether or not the change ΔDa in the traveling direction Da points in the left-hand direction relative to the Z axis.

If the change ΔDa in the traveling direction Da points in the left-hand direction relative to the Z axis, determination in step S44 becomes YES and the processing shifts to step S45.

On the other hand, if the change ΔDa in the traveling direction Da does not point in the left-hand direction relative to the Z axis, determination in step S44 becomes NO and the processing shifts to step S49.

In step S45, the comparing part 54a erases data about the left-hand direction in chronological order belonging to the data about the change ΔDw in the traveling direction Dw stored in the ring buffer 13a and having the same quantity as the change ΔDa in the traveling direction Da.

In step S46, the comparing part 54a determines whether or not the change ΔDa in the traveling direction Da is larger than a total quantity of the change ΔDw in the traveling direction Dw pointing in the right-hand or left-hand direction stored in the ring buffer 13a.

If the change ΔDa in the traveling direction Da is larger than the total quantity of the change ΔDw in the traveling direction Dw pointing in the right-hand or left-hand direction stored in the ring buffer 13a, determination in step S46 becomes YES and the processing shifts to step S47.

If the change ΔDa in the traveling direction Da is not larger than the total quantity of the change ΔDw in the traveling direction Dw pointing in the right-hand or left-hand direction stored in the ring buffer 13a, determination in step S46 becomes NO and the processing shifts to step S48.

In step S47, the comparing part 54a subtracts an excess of the change ΔDa over the total quantity of the change ΔDw in the traveling direction Dw (a quantity corresponding to the change ΔDw in the traveling direction Dw not stored in the ring buffer 13a) from the traveling direction Da.

In step S48, the traveling direction obtaining part 54b obtains a current traveling direction based on the comparison result from the comparing part 54a and the position estimating part 54c estimates a current position, thereby updating autonomous positional information.

In step S49, it is determined whether or not the user is walking (specifically, whether or not the flag indicating walking is ON).

If the user is not walking, determination in step S49 becomes NO and the processing shifts to step S50.

On the other hand, if the user is walking, determination in step S49 becomes YES and the processing returns to the autonomous positioning processing.

In step S50, the traveling direction obtaining part 54b initializes the ring buffer 13a and stores an initial value in each region of the ring buffer 13a.

The information processing device 1 of the aforementioned structure includes the acceleration sensor 17a, the first traveling direction detector 53a, the angular velocity sensor 17b, the second traveling direction detector 53b, the autonomous position updating unit 54, and the position estimating part 54c.

The acceleration sensor 17a detects an acceleration. The first traveling direction detector 53a detects a first traveling direction (traveling direction Da) based on a detection result from the acceleration sensor 17a.

The angular velocity sensor 17b detects an angular velocity.

The second traveling direction detector 53b detects a second traveling direction (traveling direction Dw) based on a detection result from the angular velocity sensor 17b.

The autonomous position updating unit (traveling direction estimating unit) 54 estimates a traveling direction of the information processing device 1 based on change in a traveling direction common to change in the first traveling direction and change in the second traveling direction.

The position estimating part 54c estimates the position of the information processing device 1 based on an estimation result from the autonomous position updating unit 54.

Thus, a current position can be obtained autonomously by comparing change (ΔDa) in the traveling direction Da obtained based on a detection result from the acceleration sensor 17a and change (ΔDw) in the traveling direction Dw obtained based on a detection result from the angular velocity sensor 17b relative to a current traveling direction and estimating a user's traveling direction based on detected change in a traveling direction common to these changes.

As a result, an autonomous position can be measured with a higher degree of accuracy in an information processing device.

The information processing device 1 further includes the ring buffer 13a.

The ring buffer 13a stores change in the second traveling direction detected by the second traveling direction detector 53b.

The autonomous position updating unit 54 compares change in the first traveling direction detected by the first traveling direction detector 53a and change in the second traveling direction stored in the ring buffer 13a. Then, the autonomous position updating unit 54 determines change common to the change in the first traveling direction and the change in the second traveling direction to be change in a traveling direction of the information processing device 1.

Thus, by adjusting a difference between timing of detection of the first traveling direction and timing of detection of the second traveling direction, changes in these traveling directions can be compared.

Further, the autonomous position updating unit 54 exempts an excess of change in the second traveling direction stored in the ring buffer 13a over change in the first traveling direction detected by the first traveling direction detector 53a from consideration. The autonomous position updating unit 54 then subtracts an excess of the change in the first traveling direction detected by the first traveling direction detector 53a over the change in the second traveling direction stored in the ring buffer 13a from the change in the first traveling direction. In this way, the autonomous position updating unit 54 calculates change in a traveling direction of the information processing device 1. Specifically, if the change in the second traveling direction stored in the ring buffer 13a is larger than the change in the first traveling direction detected by the first traveling direction detector 53a, the autonomous position updating unit 54 determines this change in the first traveling direction to be change in a traveling direction of the information processing device 1. If the change in the first traveling direction detected by the first traveling direction detector 53a is larger than the change in the second traveling direction stored in the ring buffer 13a, the autonomous position updating unit 54 obtains a difference between the change in the first traveling direction and the change in the second traveling direction as change in a traveling direction of the information processing device 1.

Thus, by using the change in the second traveling direction stored in the ring buffer 13a, change in a traveling direction common to the change in the first traveling direction and the change in the second traveling direction can be appropriately obtained.

The autonomous position updating unit 54 compares change in the first traveling direction detected by the first traveling direction detector 53a to data about change in the second traveling direction pointing in the right-hand or left-hand direction stored in the ring buffer 13a in a manner that depends on whether this detected change in the first traveling direction points in a right-hand direction or a left-hand direction relative to a vertical axis.

As a result, by using data corresponding to a pointing direction of the change in the first traveling direction detected by the first traveling direction detector 53a and belonging to data stored in the ring buffer 13a, common change in a traveling direction can be obtained.

The autonomous position updating unit 54 initializes the ring buffer 13a while the information processing device 1 is at a standstill and stores an initial value of change in a traveling direction pointing in the right-hand direction relative to the vertical axis and an initial value of change in the traveling direction pointing in the left-hand direction relative to the vertical axis.

Thus, after the initialization, change in a traveling direction common to the respective changes in the first and second traveling directions can be compared appropriately.

The aforementioned embodiment is not to limit the present invention. The present invention includes modifications, changes, etc. within a range in which the purpose of the present invention can be achieved.

In the description of the embodiment given above, the comparing part 54a obtains the change ΔDa in the traveling direction Da obtained by the first traveling direction detector 53a based on a current traveling direction. However, this is not the only way of obtaining the change ΔDa.

The change ΔDa in the traveling direction Da may be obtained by the first traveling direction detector 53a, for example.

In the aforementioned embodiment, for initialization of the ring buffer 13a, an angle obtained by dividing and storing 180 degrees is determined to be an initial value of each of the change ΔDw in the traveling direction Dw pointing in the right-hand direction and the change ΔDw in the traveling direction Dw pointing in the left-hand direction. However, this is not the only way of determining the initial value. An angle obtained by dividing and storing 180 degrees or more may be determined to be an initial value of each of the change ΔDw in the traveling direction Dw pointing in the right-hand direction and the change ΔDw in the traveling direction Dw pointing in the left-hand direction, for example.

Further, in the description of the embodiment given above, a smartphone is used as an example of the information processing device 1 to which the present invention is applied. However, this is not the only example of the applicability of the present invention.

For example, the present invention can be applied to general electronic devices having an autonomous position measuring function.

More specifically, for example, the present invention is applicable to a pedometer, wearable terminal device, portable navigation device, mobile telephone, portable game console, and the like.

The aforementioned series of processing can be implemented by hardware, and can be implemented by software.

In other words, the functional configuration of FIG. 3 is merely an exemplification, and it is not particularly limited thereto. More specifically, it is sufficient so long as a function enabling the aforementioned series of processing to be executed as a whole to be equipped to the information processing device 1, and what types of functional blocks are used in order to realize this function are not particularly limited to the example of FIG. 3.

In addition, one functional block may be configured by a unit of hardware, may be configured by a unit of software, or may be configured by a combination thereof.

In the case of having the series of processing executed by software, a program constituting this software is installed from a network or recording medium to a computer or the like.

The computer may be a computer built into dedicated hardware. In addition, the computer may be a computer capable of executing various functions by installing various programs, e.g., a general-purpose personal computer.

The storage medium containing such a program not only can be constituted by the removable medium 31 shown in FIG. 2 which is distributed separately from the device main body in order to supply the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), a Blu-ray (registered trademark) disk (Blu-ray Disk) or the like. The magnetic optical disk is composed of an MD (Mini-Disk) or the like. The storage medium supplied to the user in a state incorporated in the device main body in advance may include, for example, the ROM 12 shown in FIG. 2, a hard disk included in the storage unit 20 shown in FIG. 2 or the like, in which the program is recorded.

It should be noted that, in the present disclosure, the steps describing the program recorded in the storage medium include not only the processing executed in a time series following this order, but also processing executed in parallel or individually, which is not necessarily executed in a time series. In addition, the terminology of system in the present disclosure is to indicate the entire device constituted by a plurality of devices, a plurality of means, or the like.

Although some embodiments of the present invention have been described above, the embodiments are merely exemplifications, and are not to limit the technical scope of the present invention. Various other embodiments can be assumed for the present invention, and various modifications such as omissions and replacements are possible without departing from the spirit of the present invention. Such embodiments and modifications are included in the scope of the invention and the summary described in the present disclosure, and are included in the invention recited in the claims as well as the equivalent scope thereof.

While some embodiments of the present invention have been described so far, the scope of the present invention is not limited to the aforementioned embodiments. The scope of the present invention covers a range of the invention described in the claims and a scope equivalent to this invention.

What is claimed is:

1. An information processing device comprising:
an acceleration detector which detects an acceleration;
a first traveling direction detector which detects a first traveling direction based on a detection result from the acceleration detector;
an angular velocity detector which detects an angular velocity;
a second traveling direction detector which detects a second traveling direction based on a detection result from the angular velocity detector;
a traveling direction estimating unit which estimates a traveling direction of the information processing device based on a change in a traveling direction common to a change in the first traveling direction and a change in the second traveling direction; and
a position estimating part which estimates a position of the information processing device based on an estimation result from the traveling direction estimating unit.

2. The information processing device according to claim 1, wherein
the traveling direction estimating unit
obtains the change in the first traveling direction as a change in the traveling direction of the information processing device if the change in the second traveling direction is larger than the change in the first traveling direction, and
obtains the change in the second traveling direction as the change in the traveling direction of the information processing device if the change in the first traveling direction is larger than the change in the second traveling direction.

3. The information processing device according to claim 1, wherein
the traveling direction estimating unit obtains a change in the traveling direction of the information processing device, if a direction of the change in the first traveling direction and a direction of the change in the second traveling direction are along a same direction, by determining the same direction as a common direction of a change in the traveling direction, and by determining a smaller quantity of a change in the traveling direction as a common quantity of the change in the traveling direction, among a quantity of the change in the first traveling direction and a quantity of the change in the second traveling direction.

4. The information processing device according to claim 1, wherein
the traveling direction estimating unit compares data of the change in the first traveling direction with data of the change in the second traveling direction whose rotational direction with respect to a vertical axis is a right-hand turn or a left-hand turn based on whether the rotational direction of the change in the first traveling direction with respect to the vertical axis is the right-hand turn or the left-hand turn.

5. The information processing device according to claim 4, wherein
the traveling direction estimating unit initializes a storage unit when the information processing device is at a standstill and stores an initial value of a rotational direction of a change in the traveling direction with respect to the vertical axis, the rotational direction being a right-hand turn or a left-hand turn.

6. The information processing device according to claim 2, wherein
the traveling direction estimating unit compares data of the change in the first traveling direction with data of the change in the second traveling direction whose rotational direction with respect to the vertical axis is a right-hand turn if a rotational direction of the change in the first traveling direction with respect to a vertical axis is a right-hand turn, and compares data of the change in the first traveling direction with data of the change in the second traveling direction whose rotational direction with respect to the vertical axis is a left-hand turn if a rotational direction of the change in the first traveling direction with respect to a vertical axis is a left-hand turn.

7. An information processing method implemented in an information processing device comprising an acceleration detecting means which detects an acceleration and an angular velocity detecting means which detects an angular velocity, the information processing method comprising:
detecting a first traveling direction based on a detection result from the acceleration detecting means;
detecting a second traveling direction based on a detection result from the angular velocity detecting means;
estimating a traveling direction of the information processing device based on a change in a traveling direction common to a change in the first traveling direction and a change in the second traveling direction; and
estimating a position of the information processing device based on an estimation result about the traveling direction of the information processing device.

8. The information processing method according to claim 7, wherein
the estimating of the traveling direction includes obtaining a change in the traveling direction of the information processing device by exempting an excess of the change in the second traveling direction over the change in the first traveling direction from consideration and subtracting an excess of the change in the first traveling direction over the change in the second traveling direction from the change in the first traveling direction.

9. The information processing method according to claim 7, wherein
the estimating of the traveling direction includes obtaining a change in a traveling direction of the information processing device by considering a pointing direction of the change in the first traveling direction and a pointing direction of the change in the second traveling direction to be a common pointing direction if the change in the first traveling direction and the change in the second traveling direction point in the same direction, comparing a quantity of the change in the first traveling direction and a quantity of the change in the second traveling direction, and determining a smaller one of the quantities to be a common quantity.

10. The information processing method according to claim 7, wherein
the estimating of the traveling direction includes comparing the change in the first traveling direction to data about the change in the second traveling direction pointing in a right-hand direction or a left-hand direction in a manner which depends on whether the change in the first traveling direction points in the right-hand or left-hand direction relative to a vertical axis.

11. The information processing method according to claim 10, wherein
the estimating of the traveling direction includes initializing a storage unit while the information processing device is at a standstill and storing an initial value of change in a traveling direction pointing in the right-hand direction relative to the vertical axis and an initial value of change in the traveling direction pointing in the left-hand direction relative to the vertical axis.

12. The information processing method according to claim 7, wherein
the estimating of the traveling direction includes comparing the change in the first traveling direction to data about the change in the second traveling direction pointing in a right-hand direction if the change in the first traveling direction points in the right-hand direction relative to a vertical axis and comparing the change in the first traveling direction to data about the change in the second traveling direction pointing in a left-hand direction if the change in the first traveling direction points in the left-hand direction relative to the vertical axis.

13. A computer-readable non-transitory storage medium storing a program which causes a computer controlling an information processing device to function, the information processing device comprising an acceleration detecting means which detects an acceleration and an angular velocity detecting means which detects an angular velocity, the function of the computer comprising:
detecting a first traveling direction based on a detection result from the acceleration detecting means;
detecting a second traveling direction based on a detection result from the angular velocity detecting means;
estimating a traveling direction of the information processing device based on a change in a traveling direction common to a change in the first traveling direction and a change in the second traveling direction; and
estimating a position of the information processing device based on an estimation result from the traveling direction estimating function.

14. The computer-readable non-transitory storage medium storing the program according to claim 13, wherein
the estimating of the traveling direction includes obtaining the change in the traveling direction of the information processing device by exempting an excess of the change in the second traveling direction over the change in the first traveling direction from consideration and subtracting an excess of the change in the first traveling direction over the change in the second traveling direction from the change in the first traveling direction.

15. The computer-readable non-transitory storage medium storing the program according to claim 13, wherein
the estimating of the traveling direction includes obtaining the change in a traveling direction of the information processing device by considering a pointing direction of the change in the first traveling direction and a pointing direction of the change in the second traveling direction to be a common pointing direction if the change in the first traveling direction and the change in the second traveling direction point in the same direction, comparing a quantity of the change in the first traveling direction and a quantity of the change in the second traveling direction, and determining a smaller one of the quantities to be a common quantity.

16. The computer-readable non-transitory storage medium storing the program according to claim 13, wherein
the estimating the a traveling direction includes comparing the change in the first traveling direction to data about the change in the second traveling direction pointing in a right-hand direction or a left-hand direction in a manner which depends on whether the change in the first traveling direction points in the right-hand or left-hand direction relative to a vertical axis.

17. The computer-readable non-transitory storage medium storing the program according to claim 16, wherein
the estimating of the traveling direction includes initializing a storage unit while the information processing device is at a standstill and storing an initial value of change in a traveling direction pointing in the right-hand direction relative to the vertical axis and an initial value of change in the traveling direction pointing in the left-hand direction relative to the vertical axis.

18. The computer-readable non-transitory storage medium storing the program according to claim 13, wherein
the estimating of the traveling direction includes comparing the change in the first traveling direction to data about the change in the second traveling direction pointing in a right-hand direction if the change in the first traveling direction points in the right-hand direction relative to a vertical axis and comparing the change in the first traveling direction to data about the change in the second traveling direction pointing in a left-hand direction if the change in the first traveling direction points in the left-hand direction relative to the vertical axis.
